(19) United States
(12) Patent Application Publication
(10) Pub. No.: US 2017/0212772 A1
(43) Pub. Date: Jul. 27, 2017

(54) ANALYZING HARDWARE SYSTEMS

(71) Applicant: Hewlett Packard Enterprise Development LP, Houston, TX (US)

(72) Inventors: Lyle Wilkinson, Sunnyvale, CA (US); Tyler Easterling, Fort Collins, CO (US)

(73) Assignee: Hewlett Packard Enterprise Development LP, Houston, TX (US)

(21) Appl. No.: 15/328,270

(22) PCT Filed: Feb. 27, 2015
(86) PCT No.: PCT/US2015/018053

§ 371 Date: Jan. 23, 2017

(51) Int. Cl. G06F 9/445

(52) U.S. Cl. CPC G06F 9/4451

(57) ABSTRACT

Examples relate to analyzing hardware systems. In some examples, an interface is used to discover components and connectivity attributes of the components. System templates are then identified based on the components and the connectivity attributes. For each system template, a difference profile describing differences between the system template and the components is created.

### BACKGROUND

Site integration of complex hardware systems are typically performed via manual system integration of physical components. The integration processes can be accomplished using detailed “cookbooks” (i.e., documented instructions). Detailed verification of the system requirements may be used, which can introduce errors in the instructions and/or the manual verification process.

### BRIEF DESCRIPTION OF THE DRAWINGS

The following detailed description references the drawings, wherein:

FIG. 1 is a block diagram of an example computing device for analyzing hardware systems;

FIG. 2 is a block diagram of an example system computing device including a computing device for analyzing components in a hardware system;

FIG. 3 is a flowchart of an example method for execution by a computing device for analyzing hardware systems;

FIG. 4 is an example system template for use in analyzing hardware systems; and

FIG. 5 is an example difference map resulting from the analysis of a hardware system.

### DETAILED DESCRIPTION

As described above, complex hardware systems can be manually configured according to cookbooks. Such processes are time consuming and error prone. Examples herein use system templates that describe system types along with their component containment, hierarchy, and other dependencies as well as methods to configure the components. The system templates can be collected into a template library, which allows a collection of real system components to be examined and compared to the template library to determine compatibility of the components with the templates.

The template library enables several use cases: (1) suggesting to a system administrator alternative system types, each derived from a template that can be created from those components; (2) determining if a set of components satisfies the requirements of a particular template; (3) indicating changes (e.g., hardware addition/substitution, component connectivity changes, power configuration changes, etc.) that would allow a set of components to satisfy the requirements of a particular template; and (4) fully configuring a set of components to support the application of a particular template (e.g. applying applicable profiles to servers, applying BIOS settings, setting network configurations, allocating storage partitions and setting RAID levels on storage arrays, etc.).

In some examples, an interface is used to discover components and connectivity attributes of the components. System templates are then identified based on the components and the connectivity attributes. For each system template, a difference profile describing differences between the system template and the components is created.

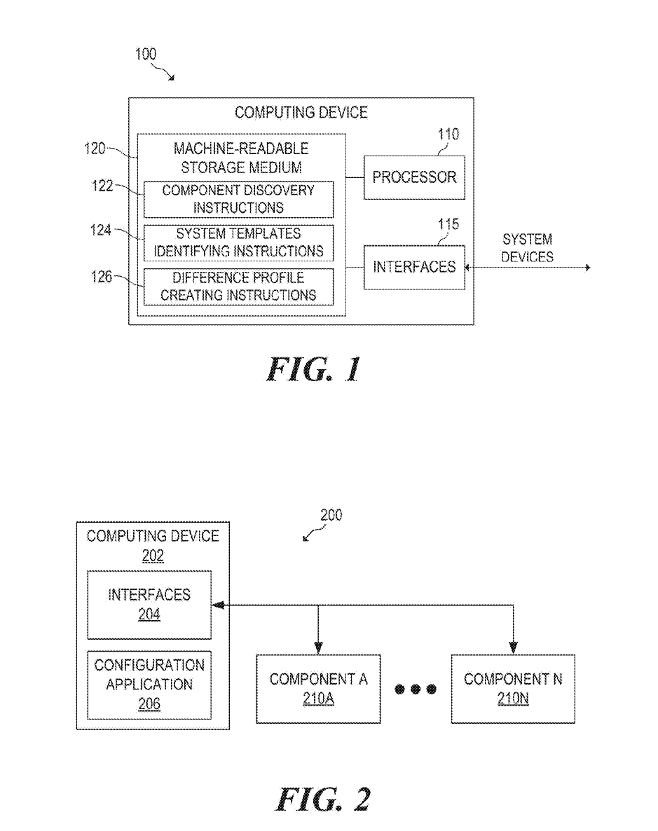

Referring now to the drawings, FIG. 1 is a block diagram of an example computing device 100 for analyzing hardware systems. The example computing device 100 may be a desktop computer, server, notebook computer, tablet, or other device suitable for analyzing hardware systems as described below. In the example of FIG. 1, networking device 100 includes processor 110, interfaces 115, and machine-readable storage medium 120.

Processor 110 may be one or more central processing units (CPUs), microprocessors, and/or other hardware devices suitable for retrieval and execution of instructions stored in machine-readable storage medium 120. Processor 110 may fetch, decode, and execute instructions 122, 124, 126 to enable analyzing hardware systems, as described below. As an alternative or in addition to retrieving and executing instructions, processor 110 may include one or more electronic circuits comprising a number of electronic components for performing the functionality of one or more of instructions 122, 124, 126.

Interfaces 115 may include a number of electronic components for communicating with computing devices. For example, interfaces 115 may be wireless interfaces such as wireless local area network (WLAN) interfaces and/or physical interfaces such as Ethernet interfaces, Universal Serial Bus (USB) interfaces, external Serial Advanced Technology Attachment (eSATA) interfaces, or any other physical connection interface suitable for communication with end devices. In operation, as detailed below, interfaces 115 may be used to send and receive data to and from other computing devices.

Machine-readable storage medium 120 may be any electronic, magnetic, optical, or other physical storage device that stores executable instructions. Thus, machine-readable storage medium 120 may be, for example, Random Access Memory (RAM), Content Addressable Memory (CAM), Ternary Content Addressable Memory (TCAM), an Electrically-Erasable Programmable Read-Only Memory (EEPROM), flash memory, a storage drive, an optical disc, and the like. As described in detail below, machine-readable storage medium 120 may be encoded with executable instructions for enabling analyzing hardware systems.

Component discovery instructions 122 use interfaces 115 to scan a network in order to identify components and connections between them. Examples of components include access points, switches, racks, server computing devices, storage arrays, etc. Component discovery instructions 122 can use various techniques for scanning the network such as, but not limited to, domain name system (DNS) service discovery, dynamic host configuration protocol (DHCP) packet inspection, DNS packet inspection, network basic input/output system (NetBIOS) inspection, etc. The discovered components can be arranged in a system map that shows the relationships between the components in the network.

System templates identifying instructions 124 identify system templates that match the components and relationships (i.e., system map) discovered above. The system templates can be preconfigured by a system administrator to create a template library of potential system configurations. Each template of the list of matching system templates should include at least some of the components from the system map.

Difference profile creating instructions 126 creates difference profiles for each template in the list of matching templates. Each difference profile specifies how closely a corresponding template matches the system map (e.g., the percentage of components from system map that are in the template, etc.). Difference profiles can be used to generate difference maps, which visually show the difference between the system map and each corresponding matching template. The difference maps can then be used by an administrator to identify a target template that can be used to modify the current hardware system.

FIG. 2 is a block diagram of an example system 200 including computing device 202 and components 210A, 210N for analyzing hardware systems. The components of computing device 202 may be similar to the corresponding components of computing device 100 described with respect to FIG. 1.

As illustrated, computing device 202 is connected to components 210A, 210N via interface(s) 204. For example, computing device 202 may be connected to a LAN or WAN that includes the components 210A, 210N. In another example, computing device 202 may be connected to a rack that includes components 210A, 210N by a USB cable. Because computing device 202 is connected to components 210A, 210N, computing device 202 is able to discover the components 210A, 210N and how the components 210A, 210N are connected to each other.

Computing device 202 also includes a configuration application 206. Configuration application 206 can provide an interface for managing system templates (e.g., creating, modifying, searching system templates, etc.). For example, a user interface can be provided that allows a user to drag-and-drop components into a system template map. In another example, auto-discovery scripts can be used to build system templates based on existing hardware systems.

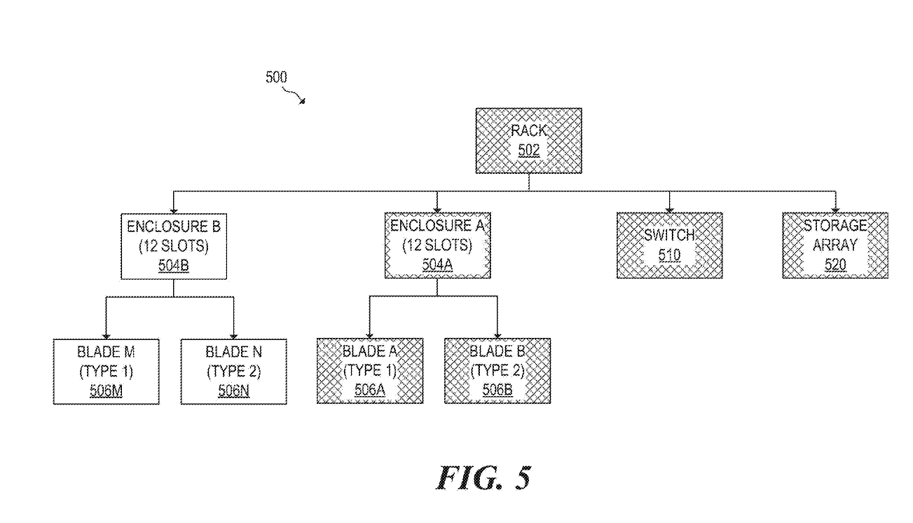

Configuration application 206 can also use the discovered data about components 210A, 210N to analyze the hardware system that includes the components 210A, 210N. For example, the discovered data can be used to generate system maps, which are compared to preconfigured system templates. In this example, configuration application 206 may allow a user to review matching templates to determine how to reconfigure the hardware system. In some cases, the differences between the components 210A, 210N and the matching templates can be visually displayed in a difference map such as the one described below with respect to FIG. 5.

When a template is selected from the matching templates, the selected template can then be used by configuration application 206 to reconfigure the components 210A, 210N. Specifically, configuration application 206 can execute configuration scripts that modify the configuration of the components 210A, 210N to match the selected system template. In this case, the configuration scripts can modify various aspects of the components 210A, 210N such as firmware configurations, application configurations, application installations, network configurations, etc. For example, the configuration scripts can reconfigure an access point to modify connections between components 210A, 210N while also installing an application on a blade of an enclosure.

Configuration application 206 can also make recommendations based on the system maps and matching system templates. For example, configuration application 206 may accept input from the user regarding the desired attributes of the hardware system (e.g., data storage, rapid response times, media streaming, etc.). In this example, configuration application 206 may use the planned uses and identified components 210A, 210N to identify the matching templates, which minimize the implementation cost.

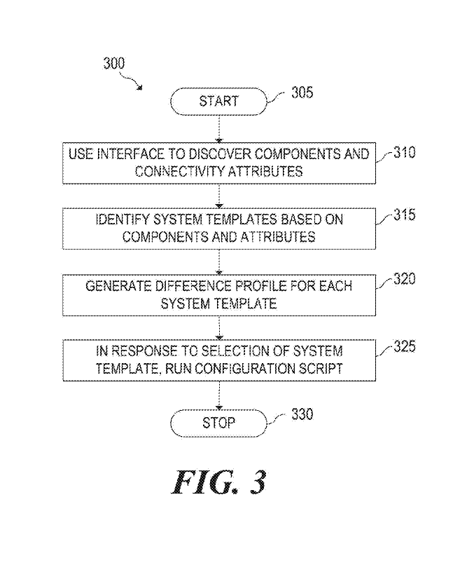

FIG. 3 is a flowchart of an example method 300 for execution by a computing device 100 for analyzing hardware systems. Although execution of method 300 is described below with reference to computing device 100 of FIG. 1, other suitable devices for execution of method 300 may be used such as computing device 202 of FIG. 2. Method 300 may be implemented in the form of executable instructions stored on a machine-readable storage medium, such as computer readable medium 120 of FIG. 1, and/or in the form of electronic circuitry.

Method 300 may start in block 305 and continue to block 310, where computing device 100 uses interface(s) to scan a network in order to discover components and connections between them. The discovered components and connections can be used to generate a system map that describes the hardware system. In block 315, computing device 100 identifies system templates that match the system map.

In block 320, computing device 100 creates difference profiles for each template in the list of matching templates. Each difference profile specifies how closely a corresponding template matches the system map. In block 325, in response to selection of one of the matching templates, configurations scripts are executed to modify the hardware system to match the selected system template. Method 300 may then continue block 330, where method 300 may stop.

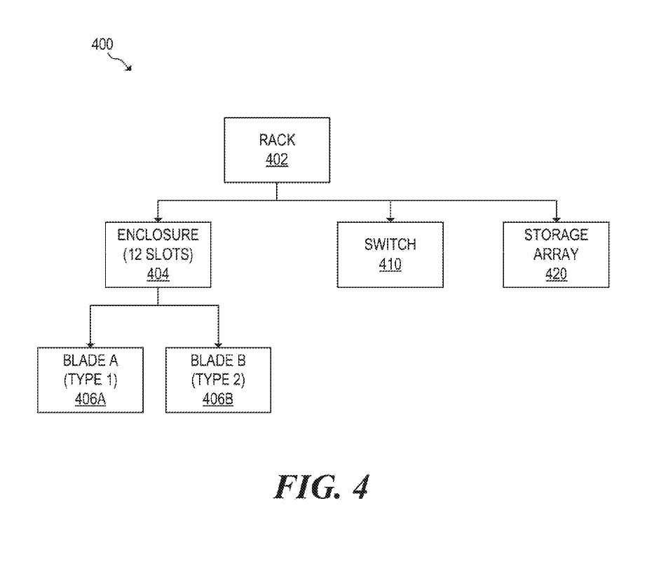

FIG. 4 is an example system template 400 for use in analyzing hardware systems. The system template 400 shows components arrange in a hardware system. The root of system template 400 is rack 402, which is connected to enclosure 404, switch 410, and storage array 420. Enclosure 404 is further connected to blade A 406A of type 1 and blade B 406B of type 2. In this example, system template 400 is shown as a hierarchical tree, where the connection between components is shown as node relationships. Similar hierarchical trees could be used to depict system maps of actual hardware systems that have been discovered as described above.

FIG. 5 is an example difference map 500 resulting from the analysis of a hardware system. The difference map 500 shows components in a hardware system as compared to the system template 400 of FIG. 4. Difference map 500 includes the same components (rack 502, enclosure A 504A, blade A 506A, blade B 506B, switch 510, storage array 520) as system template 400, which are highlighted to show where the hardware system and the system template 400 overlap. The hardware system also includes additional components (enclosure B 504B, blade M 506M, blade N 506N), which are not highlighted. Difference map 500 allows a user to quickly review an analyzed hardware system to determine how closely it matches a system template. Based on the differences, the user can adapt the hardware system to match the system template.

The foregoing disclosure describes a number of examples for analyzing hardware systems. The examples disclosed herein facilitate analyzing hardware systems by using auto-discovery to identify characteristics of hardware systems, which are used to search for matching system templates.

We claim:

1. A computing device for analyzing hardware systems, comprising:
an interface to connect to a plurality of components;
a processor to:
use the interface to discover the plurality of components and connectivity attributes of the plurality of components;
identify a plurality of system templates based on the plurality of components and the connectivity attributes; and
for each system template of the plurality of system templates, create a difference profile describing differences between the system template and the plurality of components.

2. The computing device of claim 1, wherein the processor is further to in response to a user selecting a system template of the plurality of system templates, execute a configuration script to resolve the differences in the difference profile for the system template.

3. The computing device of claim 2, wherein the processor is further to initially filter the plurality of system templates based on desired attributes specified by the user.

4. The computing device of claim 1, wherein the processor is further to generate a difference map for each of the plurality of system templates, wherein the difference map reflects the difference profile of a corresponding system template.

5. The computing device of claim 1, wherein each of the plurality of components are discovered using domain name system service discovery, dynamic host configuration protocol packet inspection, DNS packet inspection, or network basic input/output system inspection.

6. The computing device of claim 1, wherein each of the plurality of system templates are preconfigured by a user based on an existing hardware system.

7. A method for analyzing hardware systems, comprising:
using an interface to discover a plurality of components and connectivity attributes of the plurality of components;
identifying a plurality of system templates based on the plurality of components and the connectivity attributes;
for each system template of the plurality of system templates, creating a difference profile describing differences between the system template and the plurality of components; and
in response to a user selecting a system template of the plurality of system templates, executing a configuration script to resolve the differences in the difference profile for the system template.

8. The method of claim 7, further comprising initially filtering the plurality of system templates based on desired attributes specified by the user.

9. The method of claim 7, further comprising generating a difference map for each of the plurality of system templates, wherein the difference map reflects the difference profile of a corresponding system template.

10. The method of claim 7, wherein each of the plurality of components are discovered using domain name system service discovery, dynamic host configuration protocol packet inspection, DNS packet inspection, or network basic input/output system inspection.

11. The method of claim 7, wherein each of the plurality of system templates are preconfigured by the user based on an existing hardware system.

12. A non-transitory machine-readable storage medium encoded with instructions executable by a processor for analyzing hardware systems, the machine-readable storage medium comprising instructions to:
use an interface to discover a plurality of components and connectivity attributes of the plurality of components;
identify a plurality of system templates based on the plurality of components and the connectivity attributes, wherein each of the plurality of system templates are preconfigured by a user based on an existing hardware system;
for each system template of the plurality of system templates, create a difference profile describing differences between the system template and the plurality of components; and
in response to the user selecting a system template of the plurality of system templates, execute a configuration script to resolve the differences in the difference profile for the system template.

13. The non-transitory machine-readable storage medium of claim 12, wherein the instructions are further to initially filter the plurality of system templates based on desired attributes specified by the user.

14. The non-transitory machine-readable storage medium of claim 12, wherein the instructions are further to generate a difference map for each of the plurality of system templates, wherein the difference map reflects the difference profile of a corresponding system template.

15. The non-transitory machine-readable storage medium of claim 12, wherein each of the plurality of components are discovered using domain name system service discovery, dynamic host configuration protocol packet inspection, DNS packet inspection, or network basic input/output system inspection.
